(19) United States
(12) Patent Application Publication
(10) Pub. No.: US 2016/0305165 A1
(43) Pub. Date: Oct. 20, 2016

(54) STRUCTURE FOR CONNECTING A METAL LEVER AND A METAL LINK VIA A METAL PIN

(71) Applicant: AISIN SEII KABUSHIKI KAISHA, KAriya-shi, AIchi (JP)

(72) Inventors: Jun KOZUKA, Nagoya-shi, Aichi-ken (JP); Makoto SUZUMURA, Chita-shi, Aichi-ken (JP); Kenji OKADA, Anjo-shi, Aichi-ken (JP); Takashi NISHIO, Kariya-shi, Aichi-ken (JP); Yasuhiko SONO, Hekinan-shi, Aichi-ken (JP)

(73) Assignee: AISIN SEIKI KABUSHIKI KAISHA, Kariya-shi, Aichi, OT (JP)

(21) Appl. No.: 14/783,632

(22) PCT Filed: Apr. 10, 2014
(86) PCT No.: PCT/JP2014/060420

§ 371 Date: Oct. 9, 2015

(30) Foreign Application Priority Data
Apr. 11, 2013 (JP) 2013-082768

(51) Int. Cl. E05B 79/08

(52) U.S. Cl. CPC E05B 79/08

(57) ABSTRACT

A linking structure enables a metal lever and a metal link to be linked via a metal pin. The metal lever has a circular linking hole. The metal pin has a support shaft part that can rotate in the linking hole while being insertable in the linking hole and can move a set amount in the axial direction, a head part formed at one end of the support shaft part, and a linking shaft part at the other end of the support shaft part. The metal link has a joining hole in which the support shaft part is engaged, and the metal link is linked integrally with the metal pin. At least one end part in the axial direction of the support shaft part of the metal pin is provided with a permitting part for maximizing the amount of axial oscillation of the metal lever relative to the metal pin.

### TECHNICAL FIELD

The present invention relates to a structure for connecting a metal lever and a metal link via a metal pin, and can be used, for example, as a component of a vehicle door locking device (such as a vehicle door lock device, a vehicle closer device, a vehicle remote control device, or a vehicle door handle device).

### BACKGROUND ART

A structure for connecting a metal lever and a metal link to each other is used in, for example, a connecting region between an outside open lever (metal plate lever) and an open link (metal plate link) disclosed in WO 2011/118356 A1. In this connecting structure, as illustrated in FIG. 1 and FIG. 2, a connecting leg portion (hook) 12a formed on an open link 12 is inserted and engaged into a noncircular connecting hole portion 11a formed in an outside open lever 11, thereby connecting the outside open lever 11 and the open link 12 to each other. The open link 12 is connected to the outside open lever 11 so as to be rotatable by a necessary amount along a plate surface of the outside open lever 11 (along a surface of the drawing sheet of FIG. 2) under a state in which the open link 12 is capable of swinging about a connecting region between the noncircular connecting hole portion 11a and the connecting leg portion 12a by a predetermined amount in a thickness direction of the outside open lever 11 (direction orthogonal to the surface of the drawing sheet of FIG. 2).

Note that, the outside open lever 11 is pivotably mounted, at a circular support hole 11b formed in an intermediate portion thereof, to a support shaft 91a formed on a housing body 91. In the outside open lever 11, a right end portion 11c illustrated in FIG. 2 serves as an input portion, whereas the above-mentioned noncircular connecting hole portion 11a serves as an output portion. Further, the noncircular connecting hole portion 11a is formed by punching using a press. On the other hand, in the open link 12, the above-mentioned connecting leg portion 12a serves as an input portion, whereas an upper end portion 12b illustrated in FIG. 2 serves as an output portion. Further, the connecting leg portion 12a is formed by a bending process after using a press.

### SUMMARY OF INVENTION

### Problem to be Solved by the Invention

Incidentally, in the structure for connecting the metal lever (outside open lever 11) and the metal link (open link 12) to each other disclosed in WO 2011/118356 A1, the connecting leg portion (hook) 12a formed on the metal link (12) is inserted and engaged into the noncircular connecting hole portion 11a formed in the metal lever (11), thereby mounting the metal link to the metal lever. Accordingly, this structure is advantageous in that the structure is simple and can be manufactured at low cost. However, the connecting leg portion (hook) 12a comes off the noncircular connecting hole portion 11a easily at the time of assembly, and hence improvement in mountability is desired.

### Means for Solving the Problem

In order to solve the above-mentioned problem, according to the present invention, there is provided a structure for connecting a metal lever and a metal link via a metal pin, the structure including:

a metal lever having a circular connecting hole;

a metal pin comprising a support shaft portion, a head portion and a connecting shaft portion; and

a metal link having a coupling hole and being integrally connected to the metal pin, the coupling hole being fitted to the connecting shaft portion.

The support shaft portion is insertable through the connecting hole, and is pivotable and movable in an axial direction of the metal pin by a preset amount with respect to the connecting hole,

the head portion is formed at one end portion of the support shaft portion and has a diameter larger than a diameter of the support shaft portion,

the connecting shaft portion is formed at the other end portion of the support shaft portion and has a diameter smaller than the diameter of the support shaft portion, and

the metal pin comprises an allowable portion formed on at least one axial end portion of the support shaft portion of the metal pin, and the allowable portion is configured to increase an amount of swing of the metal lever on the metal pin in the axial direction of the metal pin. Note that, the above-mentioned amount of swing of the metal lever on the metal pin in the axial direction of the metal pin is a relative amount of swing. When the metal lever is incapable of swinging on the metal pin in the axial direction of the metal pin, the metal pin and the metal link swing with respect to the metal lever.

### Actions and Effects

In the above-mentioned connecting structure according to the present invention, the allowable portion is formed on the at least one axial end portion of the support shaft portion of the metal pin, and is configured to increase the amount of swing of the metal lever on the metal pin in the axial direction of the metal pin. Accordingly, the amount of swing of the metal lever on the metal pin in the axial direction of the metal pin can be ensured in a necessary and sufficient manner while minimizing a radial gap between the support shaft portion of the metal pin and the connecting hole of the metal lever at an axial intermediate portion of the support shaft portion of the metal pin.

Incidentally, in the connecting structure according to the present invention, the metal lever and the metal link are connected to each other via the metal pin, and the metal pin includes the support shaft portion pivotable and movable in the axial direction of the metal pin by the preset amount with respect to the connecting hole of the metal lever, the head portion (portion capable of preventing the metal lever from coming off the support shaft portion) being formed at one end portion of the support shaft portion and having the diameter larger than the diameter of the support shaft portion, and the connecting shaft portion (to which the metal link is integrally connected at the coupling hole after the metal lever is mounted onto the support shaft portion) being formed at the other end portion of the support shaft portion and having the diameter smaller than the diameter of the support shaft portion.

Accordingly, under a state in which the metal lever and the metal link are connected to each other via the metal pin, the metal lever is sandwiched and retained between the metal link (connected to the connecting shaft portion of the metal pin) and the head portion of the metal pin. Therefore, under a state in which the metal lever and the metal link are connected to each other via the metal pin, the metal lever and the metal link do not easily come off the metal pin, and mountability at the time of assembly can be improved.

When embodying the present invention, a second allowable portion (chamfered portion such as a C beveled portion or a R beveled portion (a rounded portion)) for increasing the amount of swing of the metal lever on the metal pin in the axial direction of the metal pin can be formed on at least one axial end portion of the connecting hole of the metal lever. In this case, the above-mentioned second allowable portion (chamfered portion such as a C beveled portion or a R beveled portion (a rounded portion)) can also increase the amount of swing of the metal lever on the metal pin in the axial direction of the metal pin.

Further, when embodying the present invention, the allowable portion can be formed so that only the one axial end portion of the support shaft portion of the metal pin has a diameter smaller than that of a center portion of the support shaft portion and only the one axial end portion has a curved surface shape in radial cross-section. In this case, the amount of swing of the metal lever to the one axial end portion side can be larger than the amount of swing to the other axial end portion side. Accordingly, a large amount of swing can be set only for a direction requiring swing.

Further, when embodying the present invention, the allowable portion can be formed so that the entire support shaft portion has a curved surface shape and a center portion of the support shaft portion of the metal pin has a maximum diameter in the support shaft portion. In this case, the amount of swing of the metal lever can be further larger than the above-mentioned case. Further, in this case, the amount of swing to the one axial end portion side and the amount of swing to the other axial end portion side can be increased equally. In this case, the allowable portion can be formed so that the support shaft portion of the metal pin has an arc shape in radial cross-section. In this case, the above-mentioned arc shape (spherical outer shape) enables the metal lever to swing more smoothly.

Further, when embodying the present invention, the metal link or the metal lever can include a protrusion regulating a swinging direction of the metal lever to a specific direction when the metal lever swings on the metal pin in the axial direction of the metal pin. In this case, an abutment portion between the metal lever and the protrusion formed on the metal link, or an abutment portion between the metal link and the protrusion formed on the metal lever can serve as a swinging fulcrum. Accordingly, the swinging direction of the metal lever on the metal pin can be stabilized. Note that, it is desired that the above-mentioned protrusion be formed as a straight protrusion extending in a radial direction of the metal pin, and the present invention can be embodied even when the above-mentioned protrusion is formed of a point-like protrusion.

Further, when embodying the present invention, a second allowable portion for increasing the amount of swing of the metal lever on the metal pin in the axial direction of the metal pin can be formed on the other axial end portion of the connecting hole of the metal lever. In this case, the amount of swing of the metal lever to the one axial end portion side (amount of swing in a case illustrated in FIG. 12 described later) can be larger than the amount of swing to the other axial end portion side. Accordingly, a large amount of swing can be set only for a direction requiring swing of the metal lever.

### BRIEF DESCRIPTION OF DRAWINGS

FIG. 1 is a side view for illustrating a related-art structure for connecting a metal lever and a metal link to each other (an example applied to a vehicle door lock device).

FIG. 2 is a back view for illustrating a relationship between the metal lever (outside open lever) and the metal link (open link) illustrated in FIG. 1.

FIG. 3 is a front view for illustrating a connecting structure according to an embodiment of the present invention.

FIG. 4 is a sectional view taken along the line 4-4 of FIG. 3.

FIG. 5 is a sectional view taken along the line 5-5 of FIG. 3.

FIG. 6 is a sectional view for illustrating a state in which an outside open lever illustrated in FIG. 4 is moved to a left end in FIG. 6.

FIG. 7 is a sectional view for illustrating a state in which an open link and a connecting pin (metal pin) swings clockwise with respect to the outside open lever illustrated in FIG. 4.

FIG. 8 is a sectional view for illustrating a state in which the open link and the connecting pin swings counterclockwise with respect to the outside open lever illustrated in FIG. 4.

FIG. 9 is a front view for illustrating a connecting structure according to another embodiment of the present invention.

FIG. 10 is a sectional view corresponding to FIG. 4, for illustrating the embodiment illustrated in FIG. 9.

FIG. 11 is a sectional view corresponding to FIG. 6, for illustrating the embodiment illustrated in FIG. 9.

FIG. 12 is a sectional view corresponding to FIG. 7, for illustrating the embodiment illustrated in FIG. 9.

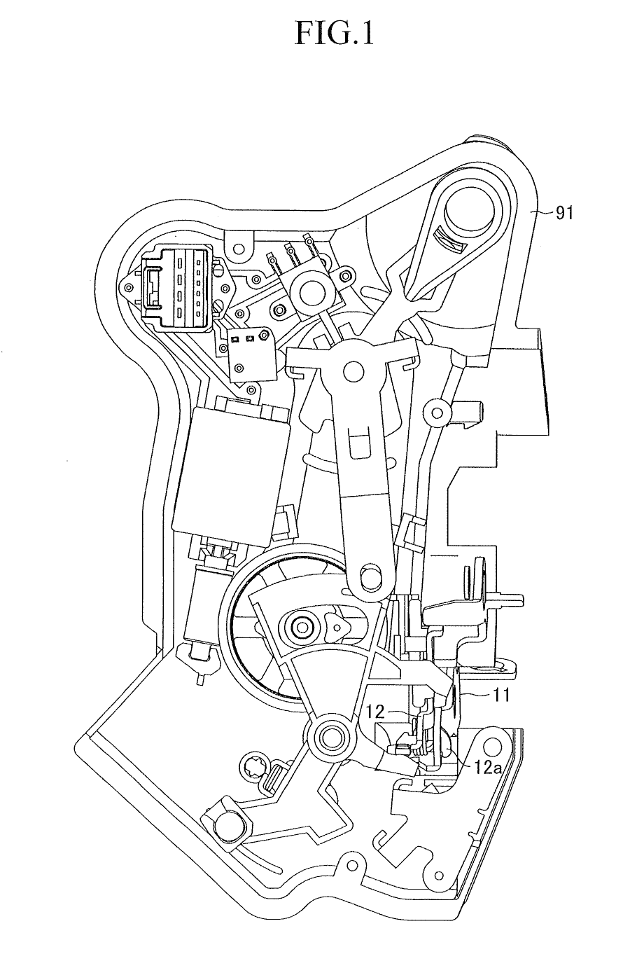

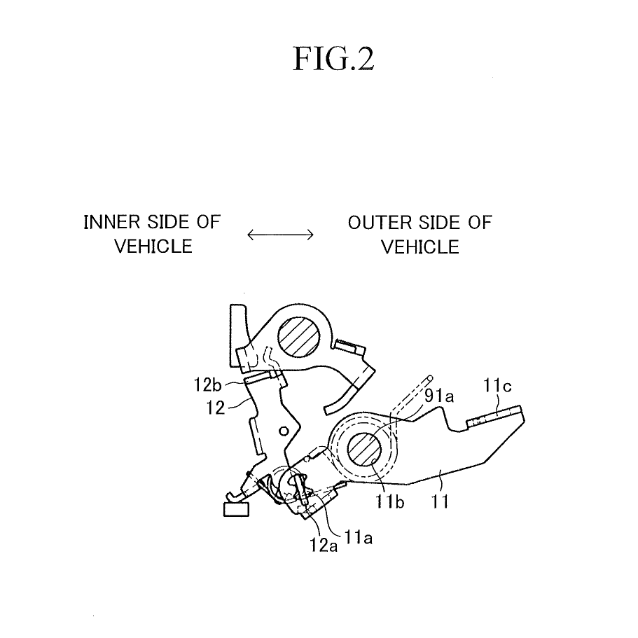

### DESCRIPTION OF EMBODIMENTS

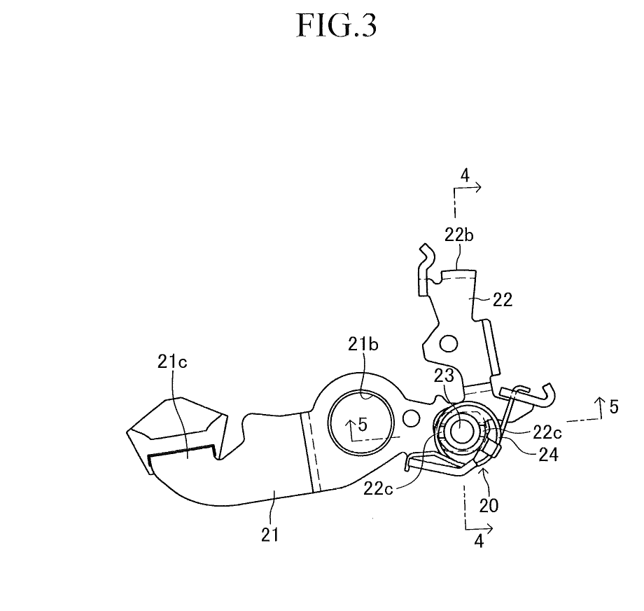

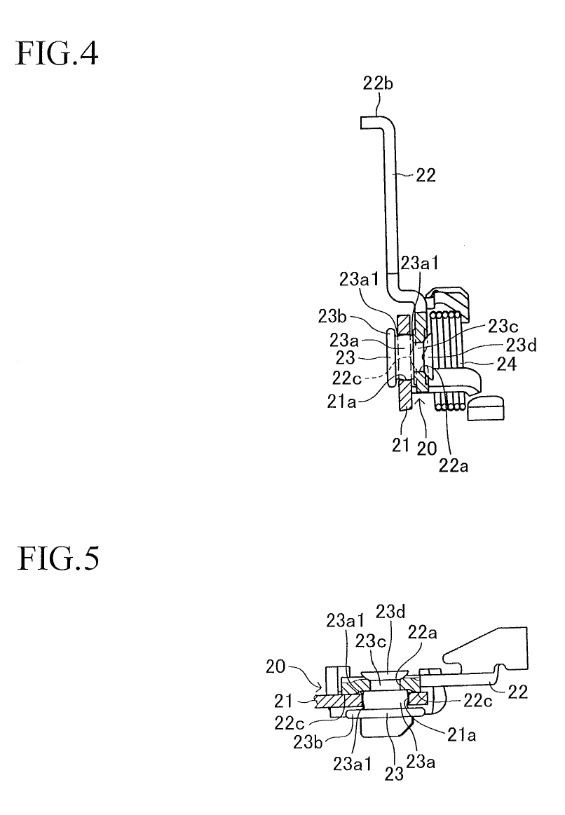

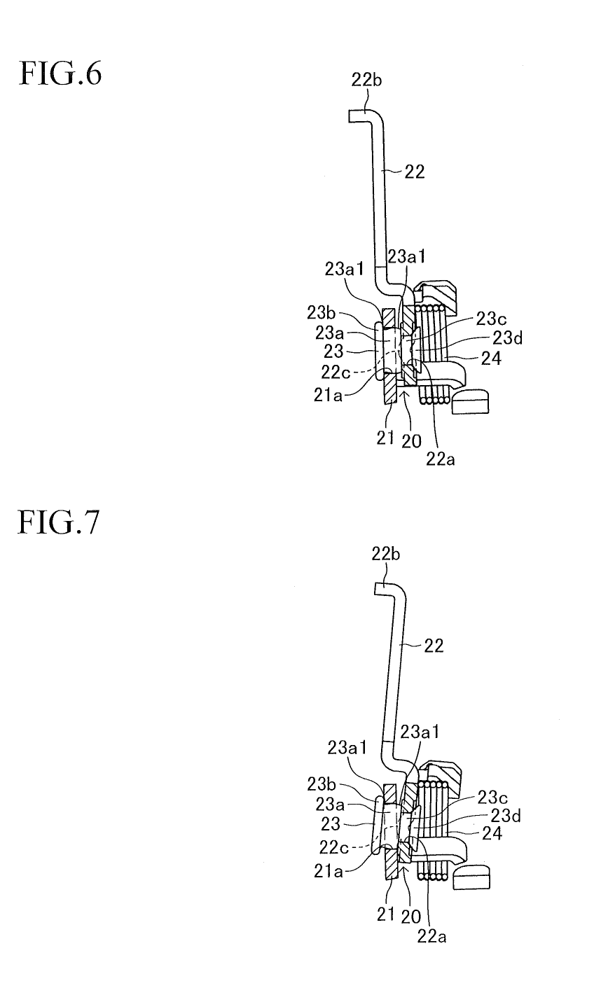

An embodiment of the present invention will be discussed with reference to the drawings. FIG. 3 to FIG. 8 are illustrations of a connecting structure according to an embodiment of the present invention, which is used as a component of a vehicle door lock device. In a connecting structure 20 according to this embodiment, an outside open lever (metal plate lever) 21 and an open link (metal plate link) 22 are connected to each other via (by) a metal connecting pin 23. Further, in the connecting structure 20, a torsion spring 24 is interposed between the outside open lever 21 and the open link 22, and the open link 22 is biased so that the open link 22 rotates clockwise in FIG. 3 and swings clockwise in FIG. 4 with respect to the outside open lever 21.

The outside open lever 21 has a circular connecting hole 21a (see FIG. 4) formed in a distal end portion thereof, and has a circular support hole 21b (see FIG. 3) formed in an intermediate portion thereof. Similarly to the outside open lever of the related art, the outside open lever 21 is configured so as to be pivotably mounted at the circular support hole 21b to a support shaft (not shown) of a housing body (not shown). A left end portion 21c of the outside open lever 21 illustrated in FIG. 3 serves as an input portion, whereas a region of the outside open lever 21, in which the above-mentioned circular connecting hole 21a is formed, serves as an output portion. Note that, at least an operation force of an outside handle, which is arranged on an outer side of a door of a vehicle, is input to the left end portion 21c. As a matter of course, an operation force of an inside handle, which is arranged on an inner side of the door of the vehicle, can be input to the left end portion 21c.

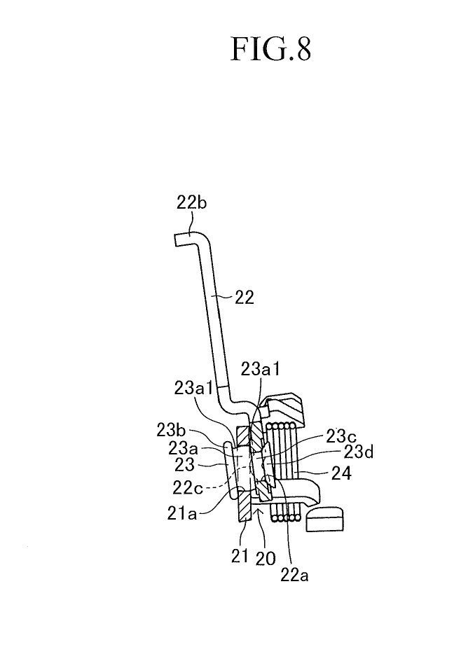

The open link 22 includes a region, which has a circular coupling hole 22a formed in a lower end portion thereof illustrated in FIG. 3, serves as an input portion, whereas an upper end portion 22b of the open link 22 illustrated in FIG. 3 serves as an output portion. The coupling hole 22a of the open link 22 is fitted into the connecting pin 23, and is integrally connected to the connecting pin 23. Further, the open link 22 includes a pair of straight protrusions 22c extending in a radial direction (horizontal direction in FIG. 3) of the connecting pin 23. Each of the straight protrusions 22c is configured to regulate a swinging direction of the outside open lever 21 to a specific direction (lateral direction in illustrations of FIG. 7 and FIG. 8) when the outside open lever 21 swings on the connecting pin 23 in an axial direction (see FIG. 7 and FIG. 8). When the open link 22 and the connecting pin 23 swing with respect to the outside open lever 21 as illustrated in FIG. 7 and FIG. 8, an abutment portion between the outside open lever 21 and each straight protrusion 22c formed on the open link 22 serves as a swinging fulcrum. Each straight protrusion 22c is formed by press working when the open link 22 is produced by press working. Note that, the upper end portion 22b outputs an input operation force to a latch mechanism which can retain the door on the vehicle body by engaging with a striker arranged on the door of the vehicle.

A support shaft portion 23a is formed in an axial intermediate region of the connecting pin 23. A head portion 23b is formed at one end portion (left end portion illustrated in FIG. 4) of the support shaft portion 23a, whereas a connecting shaft portion 23c and a swaging fixing portion 23d are formed at the other end portion (right end portion illustrated in FIG. 4) of the support shaft portion 23a. The support shaft portion 23a can be inserted through the connecting hole 21a of the outside open lever 21 (the support shaft portion 23a has an outer diameter smaller than an inner diameter of the connecting hole 21a). The support shaft portion 23a is pivotable and movable in the axial direction by a preset amount with respect to the connecting hole 21a. A spherical curved surface 23a1 (a curvature of the spherical curved surface 23a1 can be set as appropriate) is formed on each axial end portion (each lateral end portion illustrated in FIG. 4) of the support shaft portion 23a. The spherical curved surface 23a1 serves as an allowable portion for increasing an amount of swing of the outside open lever 21 on the connecting pin 23 in the axial direction.

The head portion 23b has a diameter larger than that of the support shaft portion 23a, and larger than the inner diameter of the connecting hole 21a of the outside open lever 21. Each vertical end portion of the head portion 23b illustrated in FIG. 4 is cut off by a predetermined amount so that a vertical length of the head portion 23b in FIG. 4 is smaller than a lateral length thereof in FIG. 5 by a predetermined amount. The connecting shaft portion 23c has a diameter smaller than that of the support shaft portion 23a. The connecting shaft portion 23c can be inserted through the connecting hole 21a of the outside open lever 21, and can be fitted into the coupling hole 22a of the open link 22. The swaging fixing portion 23d has a diameter smaller than that of the connecting shaft portion 23c before the swaging fixing portion 23d is swaged. After the connecting shaft portion 23c and the support shaft portion 23a are inserted through the outside open lever 21 and the open link 22 is fitted to the connecting shaft portion 23c, the swaging fixing portion 23d is swaged so as to have a diameter larger than that of the connecting shaft portion 23c. In this manner, the open link 22 is prevented from coming off.

In this embodiment configured as described above, each axial end portion of the support shaft portion 23a of the connecting pin 23 includes the allowable portion (spherical curved surfaces 23a1) for increasing the amount of swing of the outside open lever 21 on the connecting pin 23 in the axial direction. Accordingly, the amount of swing of the outside open lever 21 on the connecting pin 23 in the axial direction can be ensured in a necessary and sufficient manner while minimizing a radial gap between the support shaft portion 23a of the connecting pin 23 and the connecting hole 21a of the outside open lever 21 at an axial intermediate portion of the support shaft portion 23a of the connecting pin 23.

Incidentally, in the connecting structure 20 according to this embodiment, the outside open lever 21 and the open link 22 are connected to each other via the connecting pin 23, and the connecting pin 23 includes the support shaft portion 23a pivotable and movable in the axial direction by the preset amount with respect to the connecting hole 21a of the outside open lever 21, the head portion 23b (portion capable of preventing the outside open lever 21 from coming off the support shaft portion 23a) being formed at one end portion of the support shaft portion 23a and having a diameter larger than that of the support shaft portion 23a, and the connecting shaft portion 23c and the swaging fixing portion 23d (to which the open link 22 is integrally connected at the coupling hole 22a after the outside open lever 21 is mounted to the support shaft portion 23a) formed at the other end portion of the support shaft portion 23a.

Accordingly, under a state in which the outside open lever 21 and the open link 22 are connected to each other via the connecting pin 23, the outside open lever 21 is sandwiched and retained between the open link 22 and the head portion 23b of the connecting pin 23. Therefore, under a state in which the outside open lever 21 and the open link 22 are connected to each other via the connecting pin 23, the outside open lever 21 and the open link 22 do not easily come off the connecting pin 23, and hence mountability at the time of assembly can be improved.

Further, in the connecting structure 20 according to this embodiment, the support shaft portion 23a of the connecting pin 23 insertable through the connecting hole 21a of the outside open lever 21, and the connecting shaft portion 23c of the connecting pin 23 fitted into the coupling hole 22a of the open link 22 to be connected to the open link 22 can be produced by machining with high accuracy. Thus, the radial gap between the support shaft portion 23a of the connecting pin 23 and the connecting hole 21a of the outside open lever 21 can be produced with high accuracy. Furthermore an axial gap between the outside open lever 21, which is sandwiched and retained between the open link 22 and the head portion 23b of the connecting pin 23, and the open link 22, and an axial gap between the outside open lever 21 and the head portion 23b can be produced with high accuracy. As a result, improvement in accuracy can be achieved.

Further, in the connecting structure 20 according to this embodiment, the open link 22 includes the straight protrusions 22c for regulating the swinging direction of the outside open lever 21 to the specific direction when the outside open lever 21 swings on the connecting pin 23 in the axial direction. Thus, the abutment portion between the outside open lever 21 and each of the straight protrusions 22c formed on the open link 22 can be set as the swinging fulcrum, and the swinging direction of the outside open lever 21 on the connecting pin 23 can be stabilized. Further, in the connecting structure 20 according to this embodiment, the support shaft portion 23a of the connecting pin 23 is formed into an arc shape in radial cross-section (spherical outer shape). Accordingly, the outside open lever 21 can be smoothly swung on the connecting pin 23.

Note that, the connecting structure 20 illustrated in FIG. 3 to FIG. 8 is obtained by adopting the straight protrusions 22c as a protrusion for regulating the swinging direction of the outside open lever 21 to the specific direction when the outside open lever 21 swings on the connecting pin 23 in the axial direction. However, the protrusion can be a point-like protrusion. Further, in the connecting structure 20 illustrated in FIG. 3 to FIG. 8, the open link 22 includes the straight protrusions 22c. However, when embodying the present invention, a protrusion (protrusion capable of abutting on the open link 22) corresponding to each of the straight protrusions 22c can be formed on the open link 22 side of the outside open lever 21.

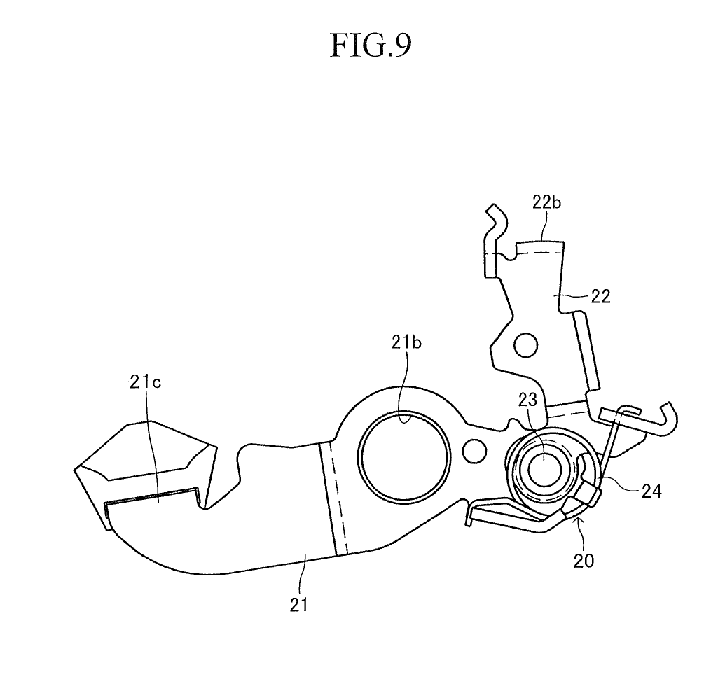

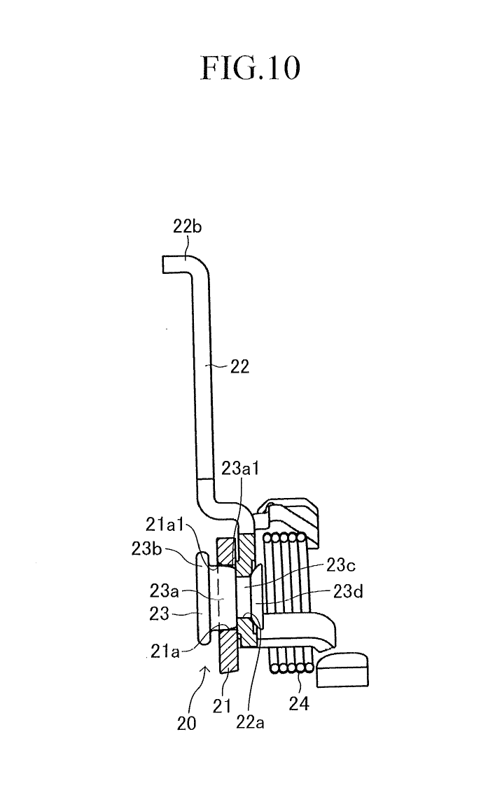

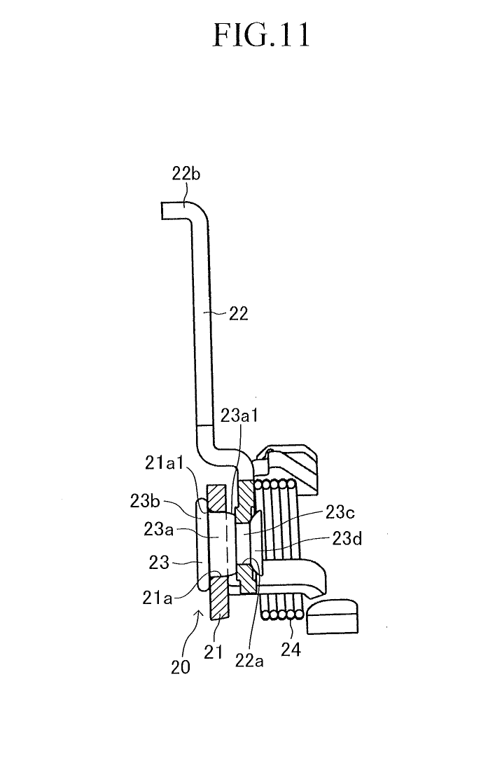

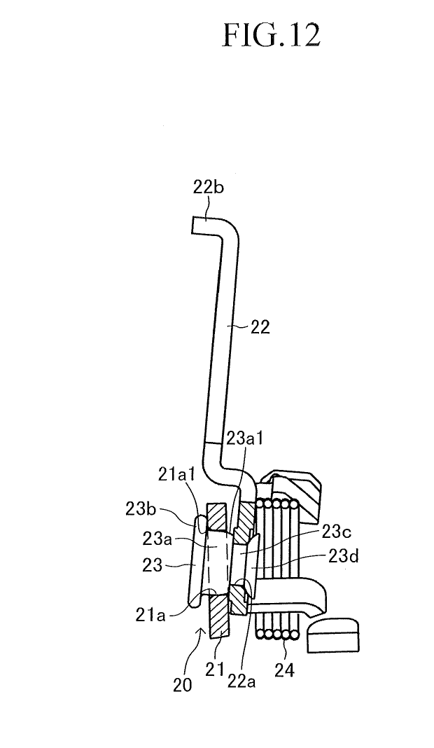

In the above-mentioned embodiment, the connecting pin 23 includes the connecting shaft portion 23c and the swaging fixing portion 23d. However, when the open link 22 can be firmly fitted and fixed onto the connecting shaft portion 23c of the connecting pin 23, the swaging fixing portion 23d can be omitted. Further, in the above-mentioned embodiment, the spherical curved surfaces 23a1 serving as the allowable portion are formed on each axial end portion of the support shaft portion 23a of the connecting pin 23. However, as in a case of another embodiment illustrated in FIG. 9 to FIG. 12, the spherical curved surface 23a1 serving as the allowable portion can be formed on one axial end portion (right end portion illustrated in FIG. 10) of the support shaft portion 23a of the connecting pin 23, and a chamfered portion 21a1 (C beveled portion or R beveled portion (rounded portion)) serving as a second allowable portion for increasing the amount of swing of the outside open lever 21 on the connecting pin 23 in the axial direction can be formed on the other axial end portion (left end portion illustrated in FIG. 10) of the connecting hole 21a of the outside open lever 21. In the another embodiment illustrated in FIG. 9 to FIG. 12, the amount of swing to the one axial end portion side (amount of swing in a case illustrated in FIG. 12) can be larger than the amount of swing to the other axial end portion side. Accordingly, a large amount of swing can be set only for a direction requiring swing.

Further, a configuration of the connecting structure 20 according to the another embodiment illustrated in FIG. 9 to FIG. 12 is obtained without forming the straight protrusions 22c on the open link 22. The configuration of the connecting structure 20 illustrated in FIG. 9 to FIG. 12 excluding the above-mentioned matter is substantially the same as the configuration of the connecting structure 20 illustrated in FIG. 3 to FIG. 8. Thus, the same configurations (components) are denoted by the same reference symbols, and description thereof is omitted. Note that, when obtaining the connecting structure 20 illustrated in FIG. 9 to FIG. 12, the spherical curved surface 23a1 serving as the allowable portion can be formed on the other axial end portion (left end portion illustrated in FIG. 10) of the support shaft portion 23a of the connecting pin 23, and the chamfered portion 21a1 (C beveled portion or R beveled portion (rounded portion)) for increasing the amount of swing of the outside open lever 21 on the connecting pin 23 in the axial direction can be formed on one axial end portion (right end portion illustrated in FIG. 10) of the connecting hole 21a of the outside open lever 21. In this case, the amount of swing to the one axial end portion side and the amount of swing to the other axial end portion side can be increased equally.

Further, in the above-mentioned embodiments, the spherical curved surface 23a1 serves as the allowable portion (allowable portion for increasing the amount of swing of the outside open lever 21 on the connecting pin 23 in the axial direction) formed on the connecting pin 23. However, the above-mentioned allowable portion only needs to have the radial cross-section having a curved surface shape (a curvature of the curved surface can be set as appropriate), and is not limited to the shape according to the above-mentioned embodiments.

Further, in the above-mentioned embodiments, the connecting structure 20 according to the present invention serves as a component of the vehicle door lock device. However, the connecting structure according to the present invention can be used as a component of vehicle door locking devices (such as a vehicle closer device, a vehicle remote control device, and a vehicle door handle device) except for the vehicle door lock device, and is not limited to the configuration according to the above-mentioned embodiments.

1. A structure for connecting a metal lever and a metal link via a metal pin, said structure comprising:
a metal lever having a circular connecting hole;
a metal pin comprising a support shaft portion, a head portion and a connecting shaft portion; and
a metal link having a coupling hole and being integrally connected to said metal pin, said coupling hole being fitted to said connecting shaft portion;
wherein said support shaft portion is insertable through said connecting hole, and is pivotabie and movable in an axial direction of said metal pin by a preset amount with respect to said connecting hole,
said head portion is formed at one end portion of said support shaft portion and has a diameter larger than a diameter of said support shaft portion,
said connecting shaft portion is formed at the other end portion of said support shaft portion and has a diameter smaller than said diameter of said support shaft portion, and
said metal pin comprises an allowable portion formed on at least one axial end portion of said support shaft portion of said metal pin, and said allowable portion is configured to increase an amount of swing of said metal lever on said metal pin in said axial direction of said metal pin.

2. The structure for connecting a metal lever and a metal link via a metal pin according to claim 1, said structure further comprising a second allowable portion formed on at least one axial end portion of said connecting hole of said metal lever, and said second allowable portion being configured to increase said amount of swing of said metal lever on said metal pin in said axial direction of said metal pin.

3. The structure for connecting a metal lever and a metal link via a metal pin according to claim 2, wherein said second allowable portion comprises a chamfered portion.

4. The structure for connecting a metal lever and a metal link via a metal pin according to claim 1, wherein said allowable portion is formed so that only said one axial end portion of said support shaft portion of said metal pin has a diameter smaller than that of a center portion of said support shaft portion and only said one axial end portion has a curved surface shape in radial cross-section.

5. The structure for connecting a metal lever and a metal link via a metal pin according to claim 1, wherein said allowable portion is formed so that said entire support shaft portion has a curved surface shape and a center portion of said support shaft portion of said metal pin has a maximum diameter in said support shaft portion.

6. The structure for connecting a metal lever and a metal link via a metal pin according to claim 5, wherein said allowable portion is formed so that said support shaft portion of said metal pin has an arc shape in radial cross-section.

7. The structure for connecting a metal lever and a metal link via a metal pin according to claim 1, wherein said metal link or said metal lever comprises a protrusion regulating a swinging direction of said metal lever to a specific direction when said metal lever swings on said metal pin in said axial direction of said metal pin.

8. The structure for connecting a metal lever and a metal link via a metal pin according to claim 4, said structure further comprising a second allowable portion formed on the other axial end portion of said connecting hole of said metal lever, and said second allowable portion being configured to increase said amount of swing of said metal lever on said metal pin in said axial direction of said metal pin.
